(19) United States
(12) Patent Application Publication
(10) Pub. No.: US 2006/0097820 A1
(43) Pub. Date: May 11, 2006

(54) Printed circuit board built-in type planar balun and method for manufacturing same

(76) Inventors: Shoji Watanabe, Nagano-shi (JP); Tsutomu Higuchi, Nagano-shi (JP)

Correspondence Address: MORGAN & FINNEGAN, L.L.P., 3 WORLD FINANCIAL CENTER, NEW YORK, NY, 10281-2101, US

(21) Appl. No.: 11/267,754

(22) Filed: Nov. 3, 2005

(30) Foreign Application Priority Data
Nov. 5, 2004 (JP) 2004-322000

(51) Int. Cl. H01P 5/10

(52) U.S. Cl. 333/26

(57) ABSTRACT

A printed circuit board built-in type planar balun which can be easily incorporated in a printed circuit board without increasing the number of layers and lowering the functions thereof is provided. A balanced signal transmission line 1 and an unbalanced signal transmission line 2 are formed on a same plane, with the sides being opposed to each other. Dielectric layers 3 are provided between these transmission lines, and between the transmission line and a ground potential layer 4 which is arranged substantially parallel to the lines 1 and 2 and spaced at a predetermined distance.

### BACKGROUND OF THE INVENTIONS

1. Field of the Invention

The present invention relates to a printed circuit board built-in type planar balun and its manufacturing method. Note that “balun” refers to a transformer which can transform a balanced signal to an unbalanced signal and which, for example, can be advantageously used to connect an antenna with a wiring part and to transform the signals in a wireless communication system. In such a use, for example, the balun is used as a chip element or a module element built into a printed circuit board.

2. Description of Related Art

There is a balun called “planar balun”, which has a transmission line on the unbalanced signal side, which has an open end and has a length equal to a half of a wavelength (λ/2) of the operating frequency, and has a pair of transmission lines, whose ends are short-circuited to the ground and have a length equal to a quarter of a wavelength (λ/4) of the operating frequency, provided on the balanced signal side through a dielectric.

When the “planar balun” is formed on a printed circuit board made of an organic resin material to manufacture “a passive element built-in substrate”, the planar balun must be provided with a four-layer structure comprised of balanced signal transmission lines, an unbalanced signal transmission line opposed thereto through a dielectric, and ground potential layers provided on the upper and lower sides of the opposed signal transmission lines through dielectric layers.

Japanese Unexamined Patent Publication (Kokai) No. 2004-172284 shows a known “planar balun” by way of example. In the “balun transformer” disclosed in this publication, in order to provide a planar balun transformer having a desired impedance without complicating the manufacturing process, first and second grounding layers and a dielectric layer therebetween are formed on a silicon substrate; and a pair of transmission lines comprised of an unbalanced signal transmission line and a balanced signal transmission line are provided in the dielectric layer substantially in parallel with the first and second grounding layers. The thickness of the dielectric layer, the distance between the unbalanced signal transmission line and the balanced signal transmission line, the amount of offset thereof, the thickness of the transmission lines, and the dielectric constant have a predetermined relationship.

In the conventional “planar balun” as disclosed in Japanese Unexamined Patent Publication (Kokai) No. 2004-172284, the ground potential layers must be provided on the upper and lower sides of the transmission lines of the balanced signal and the unbalanced signal which are opposed through the dielectric layer, through dielectrics, thus leading to a four-layer structure.

Therefore, if a balun is formed in a printed circuit board originally having not more than four layers, the number of the layers is unnecessarily increased. However, it has been found that it is possible to realize a balun of a two-layer structure by forming the balanced signal transmission line and the unbalanced signal transmission line on a same plane, and by replacing the two ground potential layers with one layer, wherein a dielectric layer is provided between the transmission lines and the ground potential layer. However, to this end, it is necessary to reduce the distance between the balanced signal transmission line and the unbalanced signal transmission line to improve the connection therebetween. The reduced distance may make it impossible to form necessary wiring, depending on the required characteristics.

Therefore, it is an object of the present invention to provide a printed circuit board-built-in type planar balun which has fewer layers while reserving its functions, and which can be easily incorporated in a printed circuit board.

Another object of the present invention is to provide a printed circuit board built-in type planar balun whose thickness can be decreased.

Still another object of the present invention is to provide a printed circuit board built-in type planar balun and its manufacturing method, wherein a sufficient space for an opposed wiring arrangement can be reserved with respect to the distance between the wirings, for the balanced signal transmission line and the unbalanced signal transmission line, even if the number of layers to be built-in in the printed circuit board is decreased.

According to an aspect of the present invention, there is provided a printed circuit board-built-in type planar balun, wherein; a balanced signal transmission line and an unbalanced signal transmission line are formed on a same plane, with the side surfaces of transmission lines being opposed to each other and a dielectric is provided between the transmission lines, and between the transmission lines and ground potential layers which are spaced at a predetermined distance and are substantially in parallel.

In an embodiment, the balanced signal transmission line is in the form of a pair of spiral coils which are arranged symmetrically; and the unbalanced signal transmission line is comprised of a single continuous coil which is disposed spirally and symmetrically, adjacent to the balanced signal transmission line.

Preferably, the aspect ratio of the thickness B of the transmission lines with respect to the distance “A” between the balanced signal transmission line and the adjacent unbalanced signal transmission line is not less than 1.0.

According to another aspect of the present invention, there is provided a method of manufacturing a printed circuit board-built-in type planar balun, comprising the steps of; forming a metal layer which defines a ground potential layer on a substrate; forming an insulating layer which defines a dielectric layer on the metal layer; forming a photosensitive resin layer on the insulating layer; exposing and developing the photosensitive resin layer along a pattern comprised of a pair of first spiral transmission lines arranged in parallel and a single second spiral transmission line which is adjacent to the first transmission line and arranged symmetrically to form a plurality of grooves in the photosensitive resin layer along the pattern on the photosensitive resin layer; embedding a metal in the grooves by plating; and smoothing the surface, in which the metal is embedded by etching or polishing.

According to another aspect of the present invention, there is provided a method of manufacturing a printed circuit board built-in type planar balun, comprising the steps of; forming a metal layer which defines a ground potential layer on a substrate; forming an insulating layer which defines a dielectric layer on the metal layer; forming a thermosetting or thermoplastic fluid resin on the insulating layer; pressing a die which has a pattern comprised of a pair of first spiral transmission lines which are arranged in symmetry and a single second spiral transmission line which is adjacent to the first transmission line and arranged symmetrically against the fluid resin to form a plurality of grooves in the fluid resin along the pattern; embedding a metal in the grooves by plating; and smoothing the surface in which the metal is embedded by etching or polishing.

### BRIEF DESCRIPTION OF THE DRAWINGS

FIG. 1(a) is an exploded schematic perspective view of a conventional 4-layered planar balun; FIG. 1(b) is a partial cross sectional view of a conventional 4-layered planar balun shown in FIG. 1(a);

FIG. 2(a) is an exploded schematic perspective view of a 2-layered planar balun according to the present invention; FIG. 2(b) is a partial cross sectional view of a 2-layered planar balun shown in FIG. 2(a);

FIG. 3 shows a method of manufacturing a 2-layered planar balun according to the present invention;

FIG. 4 shows a basic sectional shape of a 2-layered planar balun;

FIG. 5(a) shows a planar shape of an unbalanced signal transmission line in a 4-layered planar balun; FIG. 5(b) shows a cross sectional view of a 4-layered planar balun;

FIG. 6 shows a result of a simulation test of a 4-layered planar balun;

FIG. 7(a) shows an arrangement of a balanced signal transmission line and an unbalanced signal transmission line of a 4-layered planar balun in a plan view; FIG. 7(b) shows a cross sectional view of a 4-layered planar balun shown in FIG. 7(a);

FIG. 8(a) shows an arrangement of a balanced signal transmission line and an unbalanced signal transmission line of a 2-layered planar balun in a plan view; FIG. 8(b) shows a cross sectional view of a 2-layered planar balun shown in FIG. 8(a);

FIG. 9 shows a planar shape of a balanced signal transmission line and an unbalanced signal transmission line of a 2-layered planar balun according to the present invention; and

FIG. 10 shows a result of a simulation test of a 2-layered planar balun.

### DESCRIPTION OF THE PREFERRED EMBODIMENTS

Embodiments of the present invention will be described below in detail with referent to the drawings, in comparison with the prior art.

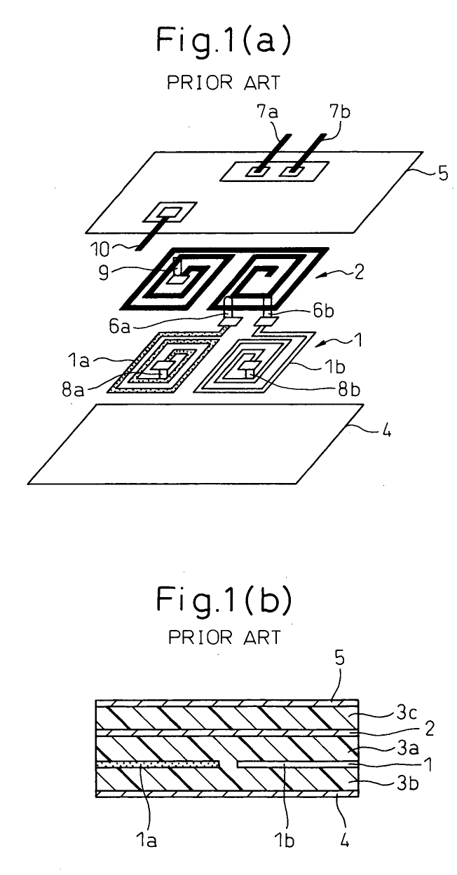

FIG. 1(a) schematically shows an exploded perspective view of a conventional 4-layered planar balun and FIG. 1(b) is a partial cross sectional view thereof. For example, a known planar balun, as disclosed in Japanese Unexamined Patent Publication (Kokai) No. 2004-172284 has a four-layer structure, as shown in FIG. 1, in which a lower balanced signal transmission line 1 and an upper unbalanced signal transmission line 2 are opposed and spaced at a predetermined distance through a dielectric 3a having a predetermined thickness.

A ground potential layer 4 is provided on the lower side of the balanced signal transmission line 1 through a dielectric layer 3b having a predetermined thickness, and, likewise, a ground potential layer 5 is provided on the upper side of the unbalanced signal transmission line 2 through a dielectric layer 3c having a predetermined thickness.

The balanced signal transmission line 1 is composed of a pair of spiral lines 1a and 1b which are coiled substantially symmetrically. The outer ends of the transmission lines 1a, 1b are connected to a pair of balanced signal transmission line terminals 7a, 7b on the upper surface through via holes 6a, 6b, respectively, and the inner ends of the transmission lines are connected to lower ground potential layer 4 through via holes 8a, 8b, respectively.

On the other hand, the unbalanced signal transmission line 2 is made of a single continuous line which is spirally bent to form a pair of substantially symmetrical coils, and the opposite ends of the coils are located in the inside of the coils. One end thereof is connected to the unbalanced signal transmission line terminal 10 through a via hole 9, and the other end is not connected to any element.

As described above, the balanced signal transmission line 1 and the unbalanced signal transmission line 2 are wound in spiral from the viewpoint of the electric characteristics and the mounting arrangement, and are opposed to each other in the thickness direction through dielectric layer 3a.

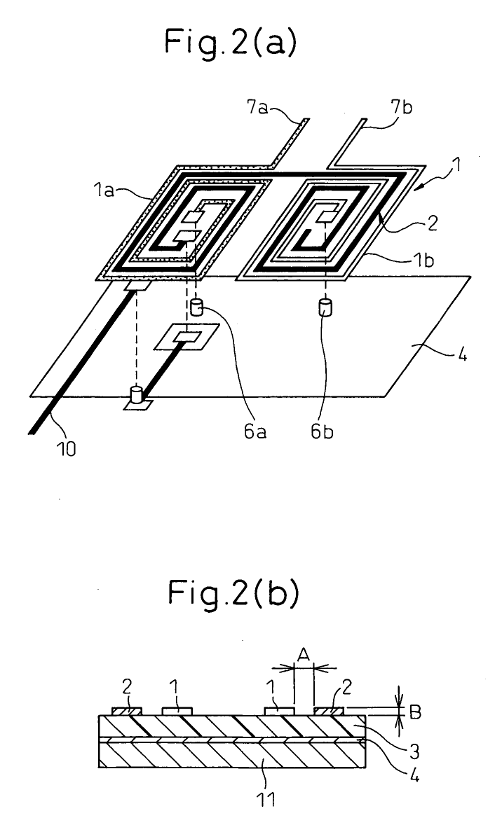

FIG. 2(a) schematically shows an exploded perspective view of a 2-layered planar balun according to the present invention and FIG. 2(b) is a partial cross sectional view of a 2-layered planar balun shown in FIG. 2(a). The planar balun according to the present invention has a two-layer structure, in which a balanced signal transmission line 1 and an unbalanced signal transmission line 2 are provided on a same plane and are spaced in the horizontal direction at a predetermined distance, with side faces of the lines 1 and 2 being opposed to each other.

The balanced signal transmission line 1 and the unbalanced signal transmission line 2 are disposed on a common ground potential layer 4 through a dielectric layer 3, to form microstrip lines.

The balanced signal transmission line 1 is composed of a pair of right and left spiral lines 1a and 1b which are arranged substantially symmetrically. The outer ends of the transmission lines 1a, 1b are connected to balanced signal transmission line terminals 7a, 7b, respectively.

On the other hand, the unbalanced signal transmission line 2 is made of a single continuous coil which is wound in spiral and symmetrically to form a pair of right and left coils. The outer circumferential line portions of these pair of coils are connected continuously to each other, and the inner ends of the inner circumferential line portions are disposed in the inside of coils. One end thereof is connected to the balanced signal transmission line terminal 10, and the other end is not connected to any element.

In the 2-layered planar balun according to the present invention, the balanced signal transmission line 1 and the unbalanced signal transmission line 2 are disposed adjacently in the same plane, with the sides thereof being opposed to each other. Thus, by arranging the balanced signal transmission line 1 and the unbalanced signal transmission line 2 in the same plane, one ground potential layer 4 can be used commonly. Consequently, the thickness of the planar balun can be decreased. In FIG. 2(b), numeral 11 demotes a substrate made of insulating resin or the like, and thus the 2-layered planar balun according to the present invention can be built in a printed circuit board having such an insulating substrate made of dielectric material.

In the 2-layered planar balun according to the present invention, as shown in FIG. 2(b), the balanced signal transmission line 1 and the unbalanced signal transmission line 2 disposed adjacently in the same plane are opposed to each other at the sides thereof, and the surface areas of the side surfaces of the transmission lines 1, 2 can be increased by increasing the thickness of the wirings of these coils. In other words, by making the thickness B of the transmission lines 1, 2 greater than the width “A” of the dielectric portion between the balanced signal transmission line 1 and the unbalanced signal transmission line 2, i.e., by making the aspect ratio not less than 1, the signal exchange characteristics can be improved in the 2-layered planar balun in which the balanced signal transmission line 1 and the unbalanced signal transmission line 2 are arranged on the same plane.

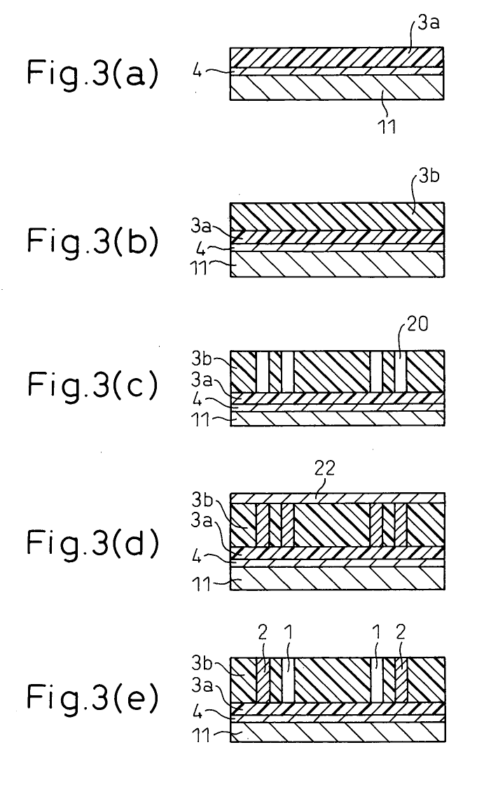

FIG. 3(a) through FIG. 3(e) show a method of forming a 2-layered planar balun having a high aspect ratio regarding the wiring of the transmission lines 1, 2, according to the present invention.

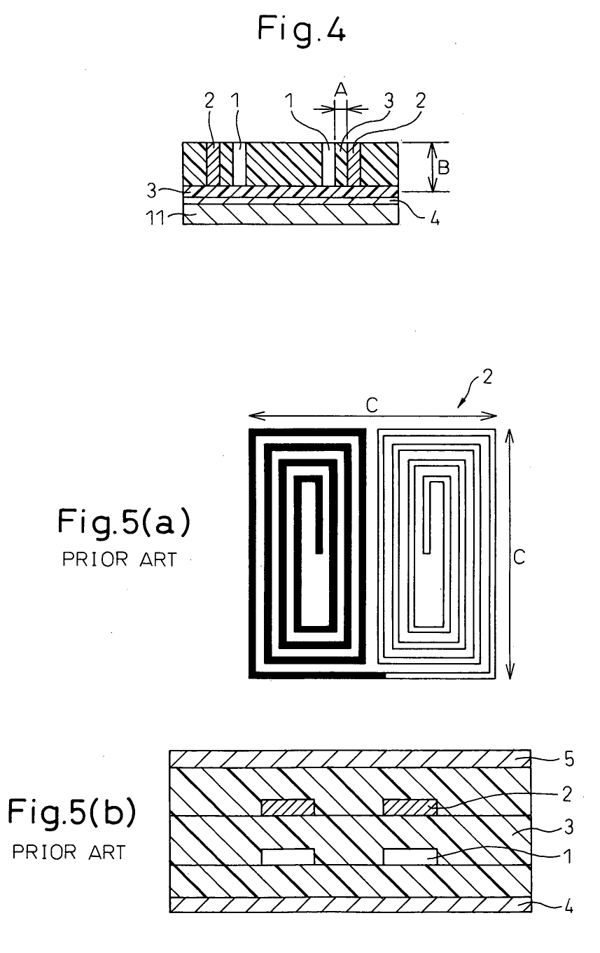

FIG. 4 shows a basic cross sectional shape of the 2-layered planar balun, wherein, the width and height of a dielectric portion 3 between the balanced signal transmission line 1 and the unbalanced signal transmission line 2 are “A” and B, respectively. As described above, by increasing the thickness B with respect to the distance “A” between the lines, the surface area between the wiring patterns can be increased, and the connection of the balun can be enhanced.

To this end, in FIG. 3(a), a metal layer 4 which serves as a ground potential layer is formed on the substrate 11, and an insulating layer 3a which serves as a dielectric layer is formed thereon.

In FIG. 3(b), a photosensitive, thermosetting or thermoplastic fluid resin 3b is formed on the insulating layer 3a. After that, as shown in FIG. 3(c), holes 20 are formed in the photosensitive, thermosetting or thermoplastic fluid resin. If the resin layer 3b is photosensitive, the holes 20 can be formed by exposing and developing the photosensitive resin in a predetermined pattern. If the resin layer 3b is made of a thermosetting or thermoplastic fluid resin, the holes 20 can be formed physically by pressing a die (not shown) having a predetermined pattern onto the resin 3b.

It goes without saying that the exposing and developing pattern, or the pattern of the die and the arrangement of holes 20 correspond to the arrangement of the wirings of the balanced signal transmission line 1 and the unbalanced signal transmission line 2.

In FIGS. 3(c) and 3(d), the holes 20 are filled with a metal (copper) 22 by copper plating. In FIG. 3(e), the upper surface coated with the metal 22 is smoothed by surface etching or polishing. By the forming process of the wiring pattern described above, the thickness B of the transmission lines 1 and 2 relative to the distance “A” between the balanced transmission line 1 and the adjacent unbalanced transmission line 2 can be increased, that is, a high aspect ratio(for example, not less than 1.0) can be obtained.

Therefore, in a manufacturing method of a planar balun according to the present invention, a planar balun of a two-layer structure (the number of the layers is less than that of the prior art) can be formed; wherein the recesses or grooves are formed in the resin layer, so that the thickness B is sufficiently larger relative to the distance “A” between the balanced signal transmission line 1 and the unbalanced signal transmission line 2, whereby the connection characteristics of the balun can be improved by an increase in the surface area of the side surfaces.

FIGS. 5 through 10 show the characteristics of the 4-layered planar balun according to the prior art and the 2-layered planar balun according to the present invention, based on a simulation test.

FIG. 5(a) shows a planar shape of the unbalanced signal transmission line 2 in the 4-layered planar balun and FIG. 5(b) shows a cross sectional view of the 4-layered planar balun. The unbalanced signal transmission line 2 is comprised of a single continuous line which is spirally wound to form two symmetrical coils, and substantially exhibits a square (for example, C=2.0 mm) shape as a whole in a plan view. The outer lines are continuously connected to each other. On the other hand, the line 2 has inner ends. As described above, the unbalanced signal transmission line 2 is opposed to the balanced signal transmission line 1 (a pair of lines 1a and 1b as shown in FIG. 1) through the dielectric layer 3. Numerals 4 and 5 represent ground potential layers.

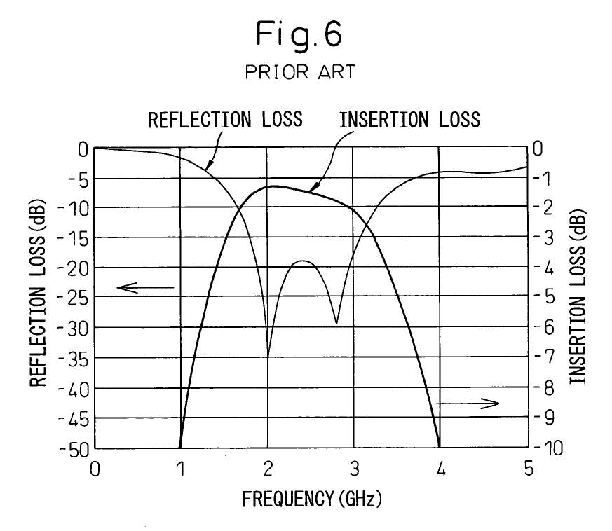

FIG. 6 shows the result of a simulation test of the 4-layered planar balun. It is obvious from FIG. 6 that the insertion loss is not more than −2 db in the frequency range of 2 to 3 GHz.

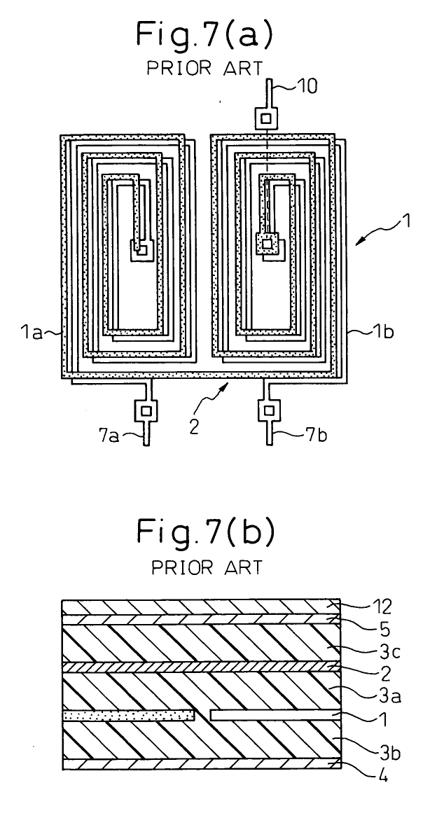

FIG. 7(a) shows an arrangement of a balanced signal transmission line and an unbalanced signal transmission line of a 4-layered planar balun in a plan view and FIG. 7(b) shows a cross sectional view of the 4-layered planar balun.

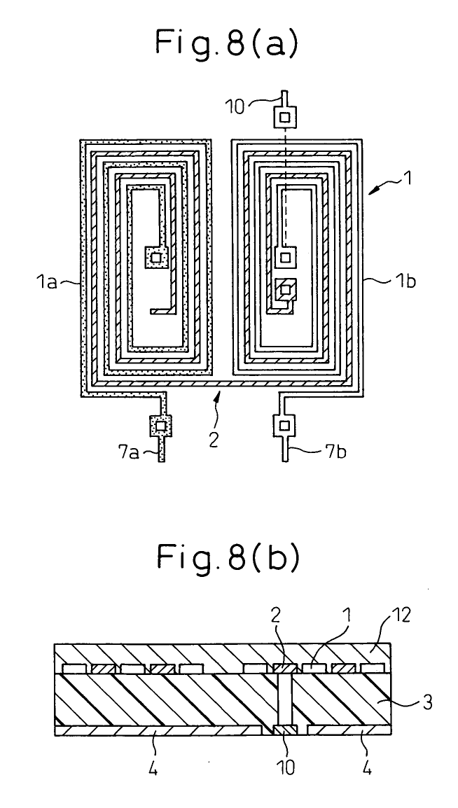

FIG. 8(a) shows an arrangement of a balanced signal transmission line and an unbalanced signal transmission line of a 2-layered planar balun in a plan view and FIG. 8(b) shows a cross sectional view of the 2-layered planar balun.

In FIGS. 7(a) and 7(b) and FIGS. 8(a) and 8(b), numeral 12 designates a surface protective layer (solder resist), and numeral 13 designates a via hole connected to an end of the unbalanced signal transmission line 2, and connected to an unbalanced signal terminal 10.

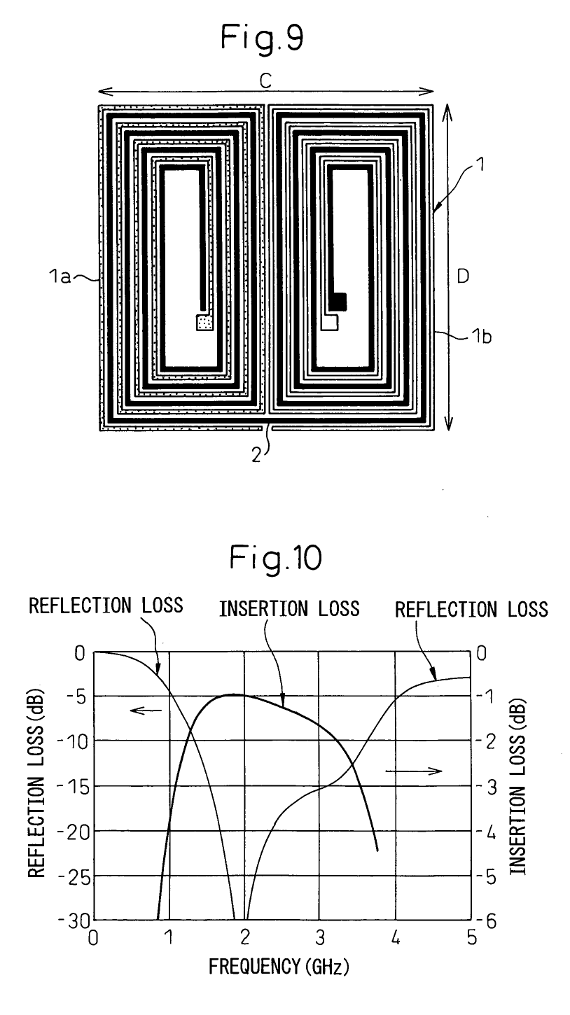

FIG. 9 shows a planar shape of a balanced signal transmission line and an unbalanced signal transmission line of a 2-layered planar balun according to the present invention. As described above, the balanced signal transmission line 1 has a shape defined by a pair of symmetrical coils 1a and 1b. On the other hand, the unbalanced signal transmission line 2 is comprised of a single continuous line which is wound in spiral to form two symmetrical coils adjacent to the balanced signal transmission line. The outer circumferential line is connected continuously. The line 2 has inner ends. The balanced signal transmission line 1 and the unbalanced signal transmission line 2 exhibit a rectangular shape (for example, C=2.2 mm, D=2.0 mm) as a whole in a plan view.

FIG. 10 shows a result of a simulation test of a 2-layered planar balun. It is obvious from FIG. 10 that the insertion loss is not more than −2 db in the frequency range of 2 to 3 GHz. According to the result, as in the simulation test of the 4-layered planar balun shown in FIG. 6, the insertion loss can be in the low level in the frequency range of 2 to 3 GHz which is the practical frequent frequency range.

Hereinbefore, the preferred embodiments of the present invention have been described with reference to the drawings, but the present invention is not limited to these embodiments, and can be modified and changed within the spirit of the present invention.

As can be seen from the foregoing, according to the present invention, the planar balun of the two-layer structure can be more simple than a 4-layered balun, without altering the functions, and the number of layers can be reduced. Thus, the planar balun of the present invention can be easily incorporated in a printed circuit board which has a small number of layers such as a communication board.

Furthermore, the thickness of the substrate can be reduced by providing built-in elements and reducing the number of the layers from 4 to 2.

Furthermore, in the manufacturing method of a planar balun according to the present invention, the planar balun in which the connection thereof can be enhanced because the thickness of the transmission line can be made sufficiently larger than the distance of the wirings, and hence, the surface area of the side faces of the transmission lines can be increased, and a number of the layers, 2, which is small, can be provided.

1. A printed circuit board built-in type planar balun, wherein; a balanced signal transmission line and an unbalanced signal transmission line are formed on a same plane, with the side surfaces of the transmission lines being opposed to each other, and a dielectric is provided between the transmission lines, and between the transmission lines and a ground potential layers which is arranged substantially in parallel to the transmission lines and spaced at a predetermined distance therefrom.

2. A planar balun according to claim 1, wherein the balanced signal transmission line is in the form of a pair of spiral coils which are arranged symmetrically; and the unbalanced signal transmission line is comprised of a single continuous coil which is arranged spirally and symmetrically, adjacent to the balanced signal transmission line.

3. A planar balun according to claim 1, wherein the aspect ratio of the thickness B of the transmission lines with respect to the distance “A” between the balanced signal transmission line and the adjacent unbalanced signal transmission line is not less than 1.0.

4. A method of manufacturing a printed circuit board built-in type planar balun, comprising the steps of;
forming a metal layer which defines a ground potential layer on a substrate;
forming an insulating layer which defines a dielectric layer on the metal layer;
forming a photosensitive resin layer on the insulating layer;
exposing the photosensitive resin layer along a pattern comprised of a pair of first spiral transmission lines symmetrically arranged to each other and a single second spiral transmission line which is adjacent to the first transmission line and arranged symmetrically, and developing to form a plurality of grooves in the photosensitive resin layer along the pattern on the photosensitive resin layer;
embedding a metal in the grooves by plating; and
smoothing the surface, in which the metal is embedded, by etching or polishing.

5. A method to manufacture a printed circuit board built-in type planar balun, comprising the steps of;
forming a metal layer which defines a ground potential layer on a substrate;
forming an insulating layer which defines a dielectric layer on the metal layer;
forming a thermosetting or thermoplastic fluid resin on the insulating layer;
pressing a die, which has a pattern comprised of a pair of first spiral transmission lines which are symmetrically arranged to each other and a single second spiral transmission line which is adjacent to the first transmission line and arranged symmetrically, against the fluid resin to form a plurality of grooves in the fluid resin along the pattern;
embedding a metal in the grooves by plating; and
smoothing the surface, in which the metal is embedded, by etching or polishing.
